(19) United States
(12) Patent Application Publication
(10) Pub. No.: US 2013/0328243 A1
(43) Pub. Date: Dec. 12, 2013

(54) MANUFACTURING APPARATUS AND METHODS OF MANUFACTURING PREFORMS, AND PREFORMS MANUFACTURED BY SAME METHOD

(71) Applicants: Toyokazu Hino, Nagoya (JP); Masaaki Yamasaki, Nagoya (JP); Ryuzo Kibe, Nagoya (JP)

(72) Inventors: Toyokazu Hino, Nagoya (JP); Masaaki Yamasaki, Nagoya (JP); Ryuzo Kibe, Nagoya (JP)

(73) Assignee: TORAY INDUSTRIES INC, TOKYO (JP)

(21) Appl. No.: 14/001,262

(22) PCT Filed: Feb. 14, 2012
(86) PCT No.: PCT/JP2012/053346

§ 371 Date: Aug. 23, 2013

(30) Foreign Application Priority Data
Feb. 24, 2011 (JP) 2011-038781

(51) Int. Cl. B29C 35/16

(52) U.S. Cl. CPC B29C 35/16
USPC 264/322; 425/520

(57) ABSTRACT

A manufacturing apparatus of a preform to be used for an RTM forming, wherein a layered body consisting of a plurality of layered reinforcing-fiber base materials to which a fixing agent consisting primarily of a thermoplastic resin is attached is formed by heating into a predetermined shape, comprising a forming mold consisting of a first mold and a second mold facing each other, wherein, only the first mold is provided with a heating mechanism and a contact face of the second mold contacting the reinforcing-fiber base material is made of a material which is less thermally conductive than the first mold.,

### TECHNICAL FIELD

This disclosure relates to manufacturing apparatus and methods of manufacturing preforms to be used for RTM (Resin Transfer Molding) forming methods, and preforms manufactured by the methods, and specifically relates to a technology capable of minimizing the heat dissipation for heating to form the preform and improving the forming accuracy.

### BACKGROUND

A conventional manufacturing method of a preform to be used for the RTM forming method comprises a series of processes as follows, (1) Layered reinforcing-fiber, base materials are placed in a forming mold and the forming, mold is closed to form a shape. (2) The forming mold is heated or preheated to make the base material hot enough to melt the fixing agent attaching to the base material. (3) The preform is cooled, to solidify the fixing agent to fix the layers of the base material to each other while, the forming mold maintains the formed shape. (4) The preform which has been formed Into a shape is removed from the forming mold. In such a forming method of preforms, it is usual that metal molds are used and comprise a lower mold and an upper mold, either of which is provided with a heating means circulating heat medium or comprising an electric heater.

If the shape supposed to be made is comparatively simple, it is possible that the forming mold comprises only a lower mold and the layered base material is placed on the lower mold and put in a bagging film, and the space between the film and the mold is vacuumed to press the base material through the film by atmospheric pressure to form a predetermined shape, as disclosed in JP2006-123404-A. However, such a forming method using the film requires human hands which results in low productivity and high cost. For such a reason, both upper mold and lower mold are often used for the forming molds. JP2006-123402-A discloses upper and lower molds made of aluminum. For example, to form a complicated three-dimensional shape, JP2009-119701-A discloses a plurality of movable upper molds.

However, if the upper and lower molds both are made of metal, the following problems are expected.

First, if the lower mold only is provided with the heating means, heat dissipation toward the upper mold, at the opposite side becomes greater and, therefore, the lower mold must be heated excessively to keep the forming temperature constant. Consequently, energy saving is difficult because heating requires a large amount of energy. Second, if the lower mold only is provided with the heating means and insulation material such as foaming material is provided to the upper mold, dimensional accuracy of the formed preform might decrease because the insulation material such as foaming material deforms while being pressed to form the shape. On the other hand, if the upper and lower molds both are provided with the heating means, it is difficult to make at least one of the molds a split mold to form a complicated shape.

Accordingly, with the above-described problems in mind, it could be helpful to provide manufacturing apparatus and method of manufacturing preforms, and preforms manufactured by the methods, wherein energy savings can be achieved, with low heat dissipation and high heating efficiency, and even a preform formed into a complicated shape can reliably and easily be manufactured to be used for RTM (Resin Transfer Molding) forming method with high dimensional accuracy.

### SUMMARY

We provide a manufacturing apparatus of a preform to be used for an RTM forming, wherein a layered body consisting of a plurality of layered reinforcing-fiber base materials to which a fixing agent consisting primarily of a thermoplastic resin is attached is formed by heating into a predetermined shape, including a forming mold consisting of a first mold and a second mold facing each other, wherein only the first mold is provided with a heating mechanism and a contact face of the second mold contacting the reinforcing-fiber base material is made of a material which is less thermally conductive than the first mold.

We also provide a method of manufacturing preforms to be used in RTM forming, including pressing a layered body consisting of a plurality of layered reinforcing-fiber base materials to which a fixing agent consisting primarily of a thermoplastic resin is attached with a forming mold consisting of a first mold and a second mold facing each other to form a predetermined shape; heating the predetermined shape to melt the fixing agent interposed among the reinforcing-fiber base materials only from a first mold side and a contact face of the second mold contacting the reinforcing-fiber base material is made of a material which is less thermally conductive than the first mold so as to suppress the heat from being conducted to the second mold side, and cooling to solidify the fixing agent to make the reinforcing-fiber base materials adhere to each other to maintain a formed shape.

We further provide a preform for RTM forming and manufactured by a method including pressing a layered body consisting of a plurality of layered reinforcing-fiber base materials to which a fixing agent consisting primarily of a thermoplastic resin is attached with a forming mold consisting of a first mold and a second mold facing each other to form a predetermined shape; heating the predetermined shape to melt the fixing agent interposed among the reinforcing-fiber base materials only from a first mold side and a contact face of the second mold contacting the reinforcing-fiber base material, is made of a material which is less thermally conductive than the first mold so as to suppress the heat from being conducted to the second mold side, and cooling to solidify the fixing agent to make the reinforcing-fiber base materials adhere to each other to maintain a formed shape.

### BRIEF EXPLANATION OF THE DRAWINGS

FIG. 1 is a schematic cross-sectional view of a manufacturing apparatus of a preform according to the present invention.

FIG. 2 is a schematic structural view of a test apparatus used in the examples and comparative examples of the present invention.

FIG. 3 is a schematic characteristic diagram showing a temperature distribution in the example of the present invention.

### EXPLANATION OF SYMBOLS

1: preform manufacturing apparatus

2: lower mold as first mold

3: upper mold as second mold

4: forming mold

5: layered body of reinforcing-fiber base material

6: heating mechanism

7: cooling means

8: pressing mechanism

Q: heat transfer

l,l₁-l₇: thickness

T, T₁-T₈: temperature on contact face

λ, λ₁-λ₇: thermal conductivity

### DETAILED DESCRIPTION

We provide a manufacturing apparatus of preforms to be used for RTM forming, wherein a layered body consisting of a plurality of layered reinforcing-fiber base materials to which a fixing agent consisting primarily of a thermoplastic resin is attached is formed into a predetermined shape as heated in a forming mold consisting of a first mold and a second mold which are facing each other, characterized in that only the first mold is provided with a heating mechanism and a contact face of the second mold contacting the reinforcing-fiber base material is made of a material which is less thermally conductive than the first mold.

In the manufacturing apparatus, although heating is performed only from the side of one mold (first mold) of the forming mold which is provided with the heating mechanism, the heat is less conducted to the other mold (second mold) and then is less dissipated from the second mold to the outside because the second mold is made of material less thermally conductive. As a result, the layered body placed in the forming mold and is made of reinforcing-fiber base materials to which the fixing agent consisting primarily of the thermoplastic resin is attached is efficiently heated to a predetermined temperature with less heat. Saving energy is enabled by raising the heating efficiency. Further, the dimensional accuracy in forming preforms can be improved since an insulation material which tends to deform is not necessary. Furthermore, because the other mold (second mold) having no heating mechanism can be configured to a split mold easily, complicated shapes can be formed with high dimensional accuracy.

It is preferable that the contact face is made of a material having a thermal conductivity which is equal to or more than 0.01 W/m·K and is equal to or less than 10 W/m·K, and more preferably, made of a material having a thermal conductivity which is equal to or less than 5 W/m·K. It is preferable that the thermal conductivity of a formation material of the second mold is low to achieve the above-described high heating efficiency and excellent energy saving. However, if the thermal conductivity of the contact face is too low to dissipate the heat from the inside of the forming mold which is closed and cooled in a process of solidifying the fixing agent, it might take a long time to cool the preform. Therefore, it is preferable that the contact face is made of a material having a thermal conductivity which is equal to or more than 0.01 W/m·K, and more preferably, is equal to or more than 0.1 W/m·K.

The formation material of the contact face may be a nonmetallic material having a thickness of at least 5 mm and is preferably a material such as a resin which is less thermally conductive and thermally resistant from a viewpoint of the easy manufacturing. General-purpose resins such as epoxy resin (thermal conductivity: 0.2-0.4 W/m·K), phenolic resin (thermal conductivity: 0.13-0.25 W/m·K), Bakelite resin (thermal conductivity: 0.33-0.6 W/m·K) and PTFE resin (approximately 0.25 W/m·K) may be used. Also other materials such as chemical wood (thermal conductivity: 0.1-1.8 W/m·K) and heat-resistant board material (e.g. Lossna-board (made by Nikko Kasei Co., Ltd.) thermal conductivity: 0.24 W/m·K) may be used. However, the formation material of the contact face is not limited to the materials exemplified above. Further, the formation material is required to have a heat resistance large enough to resist the temperature at which the preform is formed as well as the temperature at which the thermoplastic resin as the fixing agent is melted.

A thin nonmetallic material such as a film is not suitable as the formation material of the contact face. As described above, the forming process by using bagging films might require human manipulation which decreases productivity and increases cost. Further, the formation might not be achieved at the second mold side. Still further, because thin materials are sensitive to the ambient temperature, the heat conducted from the first mold provided with the heat source might be dissipated. Therefore, the heat source should be provided even at the second mold side. It is preferable that the second mold has a thickness of at least 5 mm.

In contrast, it is preferable that the first mold is made of a material having a comparatively high thermal conductivity capable of conducting the heat to the base material side and is specifically made of metal. For example, aluminum (thermal conductivity: 204-230 W/m·K), carbon steel (thermal conductivity: 36-53 W/m·K), or chrome steel (thermal conductivity: 22-60 W/m·K) may be used. However, the formation material of the first mold is not specifically limited to the examples described above.

As described above, the second mold is not provided with the heating mechanism and, therefore, can easily be made a split mold. The split mold can be applied to the forming of a preform into a complicated shape.

The material of the reinforcing-fiber base material composing the layered body is not limited specifically, and may be carbon fiber base material, glass fiber base material, aramid fiber base material, or hybrid reinforcing-fiber base material consisting of them. Above all, our apparatus and methods are specifically effective in the case where the reinforcing-fiber base material is made of carbon fiber base material which requires the preform to be formed with a high dimension accuracy in the RTM forming method.

As to the reinforcing-fiber base material used in the manufacturing apparatus, it is preferable that the fixing agent has a glass transition temperature (Tg) of 50-80° C. If the Tg of the fixing agent is less than 50° C., the base materials might adhere to each other at the time of transportation of the base material and decrease handleability. In contrast, if Tg is more than 80° C., the forming temperature must be raised so that particularly the second mold might have to be made of a special material having a high heat resistance.

It is preferable that the fixing agent attaching to the surface of the reinforcing-fiber base material primarily consists of a thermoplastic resin. The thermoplastic resin may be polyamide, polysulfone, polyetherimide, polyphenylene ether, polyimide, polyamide-imide or polyvinyl formal, and is not limited in particular.

If the resin material primarily consists of thermoplastic resin, productivity improves as does handleability, when the resin material is sprayed on the reinforcing fiber fabric to be solidified and also when the layers are fixed after the reinforcing fiber fabric is layered and transformed into a three-dimensional shape. Besides, what the resin material primarily consists of is the element which has the greatest proportion and is called the primary constituent element. That doesn't exclude instances where the fixing agent contains a thermosetting resin such as epoxy resin and phenolic resin and, therefore, thermoplastic resin and/or thermosetting resin can be selected.

Our manufacturing methods can be used for RTM forming, wherein a layered body consisting of a plurality of layered reinforcing-fiber base materials to which a fixing agent consisting primarily of a thermoplastic resin is attached is pressed with a forming mold consisting of a first mold and a second mold facing each other to be formed into a predetermined shape as heated to melt the fixing agent interposed among the reinforcing-fiber base materials, and then cooled to solidify the fixing agent to make the reinforcing-fiber base materials adhere to each other to maintain the formed shape, characterized in that the heating is performed only from the first mold side and a contact face of the second mold contacting the reinforcing-fiber base material is made of a material which is less thermally conductive than the first mold to suppress heat from being conducted to the second mold side.

Even in such a manufacturing method, it is preferable that the contact face is made of a material having a thermal conductivity which is equal to or more than 0.01 W/m·K and is equal to or less than 10 W/m·K, and more preferably, made of a material having a thermal conductivity which is equal to or less than 5 W/m·K.

Also, it is preferable that the contact face is made of a nonmetallic material having a thickness of at least 5 mm, as exemplified above. Further, it is preferable that the first mold is made of a metallic material as exemplified above. However, for the above-described reason, it is preferable that the contact face is made of a material having a thermal conductivity which is equal to or more than 0.01 W/m·K, and more preferably, is equal to or more than 0.1 W/m·K.

Further, it is possible that the second mold which is not provided with a heating mechanism is a split mold, which can easily be applied to the forming of a complicated shape with a high dimension accuracy.

In the manufacturing method, it is possible that the cooling is performed while the layered body is pressed. If the cooling is performed while the pressing force is being released, the fixing agent might be solidified in the released system and, therefore, the dimensional accuracy of the preform might decrease. Otherwise, the cooling operation can be performed continuously after the forming operation is performed by heating so that the production efficiency is improved and the forming time is shortened.

Further, our apparatus and methods are specifically effective in the case where the reinforcing-fiber base material is made of carbon fiber base material, though the reinforcing-fiber base material is not limited in particular.

It is preferable that the fixing agent has a glass transition temperature (Tg) of 50-80° C.

Furthermore, we provide preforms manufactured by the above-described methods. We make it possible that a preform having a high dimension accuracy is manufactured efficiently with less thermal energy.

Thus, the base material is heated efficiently as suppressing the heat dissipation so that the energy saving is achieved by improving heating efficiency. Further, even in the case where a complicated shape is to be formed, a desirable preform used for the RTM forming method can be manufactured surely and easily with a high dimension accuracy and a high productivity.

Hereinafter, our apparatus and methods will be explained with reference to the figures.

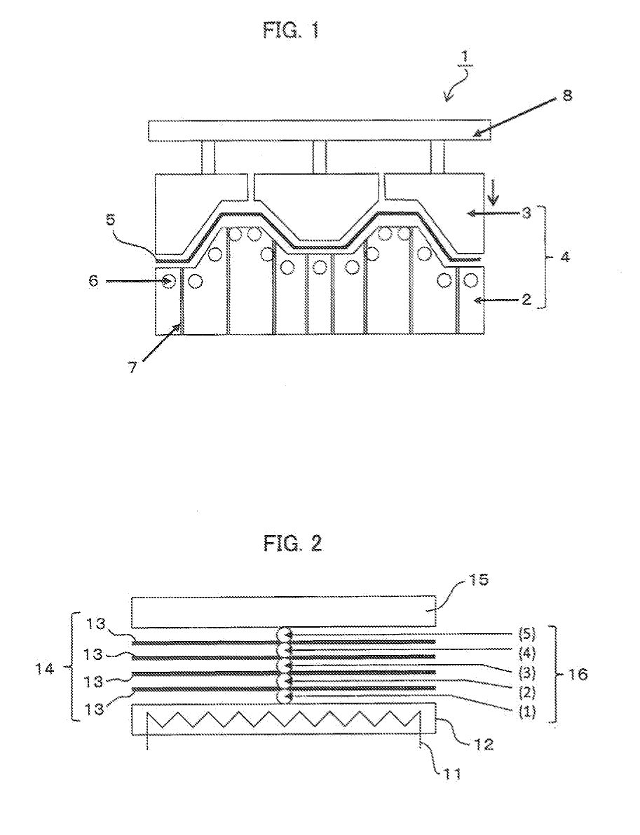

FIG. 1 shows an example of a preform manufacturing apparatus 1. In preform manufacturing apparatus 1, layered body 5 with a plurality of layered reinforcing-fiber base materials to which fixing agent consisting primarily of thermoplastic resin is attached is placed in forming mold 4 consisting of lower mold 2 as a first mold and upper mold 3 as a second mold facing each other. Only lower mold 2 is provided with heating mechanism 6 as a flow passageway of heat medium in which hot water or heated oil circulates. In this example, lower mold 2 is also provided with cooling device 7 of the air-cooling type or water-cooling type. The heating mechanism may be provided with a heater, other than the above-described mechanism in which the heat medium circulates. Cooling device 7 may cool a preform with compressed air flowing through through-holes toward the preform and, alternatively, may circulate coolant water provided in a passageway inside lower mold 2. Upper mold 3 without heating mechanism 6 is configured as a split mold consisting of divided mold pieces. Upper mold 3 is coupled to pressing mechanism 8 which is capable of moving upper mold 3 with respect to lower mold 2 to open and close a set of molds and is capable of generating the pressing force to form layered body 5.

Layered body 5 is placed in forming mold 4, in which layered body 5 is formed into a predetermined shape by heating with lower mold 2 and pressing with upper mold 3 through pressing mechanism 8 so that a preform is manufactured to be used for the RTM forming method. Upper mold 3 of forming mold 4 is made of a material less thermally conductive than lower mold 2. More specifically, lower mold 2 may be made of metal such as aluminum (thermal conductivity at 20° C.: 228 W/m·K), aluminum alloy and steel (thermal conductivity as pure iron at 20° C.; 72.7 W/m·K), while upper mold 3 may be made of a thermally-resistant resin such as phenolic resin (thermal conductivity at 20° C.: 0.233 W/m·K).

In preform manufacturing apparatus 1, layered body 5 is formed into a predetermined shape by pressing between lower mold 2 and upper mold 3 of forming mold 4, while the fixing agent among the reinforcing-fiber base materials is melted by heating from the side of lower mold 2 with heating mechanism 6 and the melted fixing agent is solidified by cooling with cooling device 7 to fix the reinforcing-fiber base materials to each other to maintain the formed shape. The heating described above is performed only from the side of lower mold 2 provided with heating mechanism 6, and the heat is less conducted to upper mold 3 and then is less dissipated from upper mold 3 to the outside because upper mold 3 is made of material less thermally conductive than lower mold 2. As a result, being placed in forming mold 4, layered body 5 of the reinforcing-fiber base material to which the fixing agent consisting primarily of thermoplastic resin is attaching is heated efficiently with minimum quantity of heat, and then the base materials are fixed with the solidified fixing agent to each other. Thus, the heating efficiency of heating mechanism 6 is increased and, therefore, the energy saving can be achieved by the reduction of energy to be consumed in forming shapes. Further, dimensional accuracy in forming preforms can be improved since the above-described insulation material which tends to deform is not necessary. Furthermore, because upper mold 3 having no heating mechanism 6 can be configured to a split mold as depicted, complicated shapes can be formed with a high dimension accuracy.

FIG. 2 shows a test apparatus used to study the desired effects. Layered body 14 consisting of four carbon fiber fabric 13 is set on lower mold 12 which has been heated to 100° C. and provided with a heater as heating mechanism 11 and, then, after closing the mold with upper mold 15, temperature at each section is measured by thermocouples 16 [(1), (2), (3), (4), (5)] located among the carbon fiber fabrics 13 as well as at both sides of layered body 14. Upper mold 15 is not provided with a source of heat. In the example, lower mold 12 is made of aluminum, and upper mold 15 is made of resin (chemical wood, thermal conductivity: 1.5 W/m·K). In the comparative example, lower mold 12 is made of aluminum (thermal conductivity: 228 W/m·K) and even upper mold 15 is made of aluminum. The mold is closed and then the temporal response of temperature at each section is measured. Table 1 shows results of the test.

TABLE 1

| | Temperature at each section (° C.) | | | | | | | | | |
|---|---|---|---|---|---|---|---|---|---|---|
| | <Examples> | | | | | <Comparative Examples> | | | | |
| | Upper mold: Resin product | | | | | Upper mold: Aluminum product | | | | |
| Elapsed time from | Lower mold: Aluminum product | | | | | Lower mold: Aluminum product | | | | |
| closing mold (s) | (1) | (2) | (3) | (4) | (5) | (1) | (2) | (3) | (4) | (5) |
| 10 | 97.3 | 98.3 | 96.5 | 94.7 | 94.5 | 79.2 | 73.9 | 61.2 | 51.9 | 46.3 |
| 30 | 99.9 | 101.0 | 99.8 | 98.6 | 97.4 | 76.9 | 71.2 | 60.4 | 52.0 | 45.0 |
| 60 | 100.2 | 101.1 | 100.0 | 98.8 | 97.6 | 76.3 | 71.6 | 60.9 | 52.9 | 45.9 |
| 100 | 100.3 | 101.1 | 100.1 | 98.8 | 97.7 | 76.5 | 71.8 | 61.3 | 53.6 | 46.7 |
| 300 | 100.2 | 100.9 | 99.9 | 98.5 | 97.6 | 77.0 | 72.7 | 63.3 | 56.1 | 49.4 |
| 600 | 100.0 | 100.9 | 99.8 | 98.3 | 97.4 | 78.1 | 73.9 | 65.8 | 59.1 | 53.0 |

As shown in Table 1, even the temperature at section (5) which is the furthest from the source, of heat arrives at 97.4° C. in the example where the upper mold is made of resin. That result indicates that the heat given from the lower mold is not conducted to the less thermally conductive upper mold and mostly consumed to heat the carbon fiber fabric. On the other hand, in the comparative example where the upper mold is made of thermally conductive aluminum, the temperature at section (3) which is the furthest from the source of heat only arrives at 53.0° C. after 600 seconds and even the temperature at section (1) which is the closest to the source of heat only increases to 78.1° C. That result indicates that the heat given from the lower mold is dispersing to the upper mold side. The preform obtained in the example is the one with layers firmly fixed to each other. On the other hand, unmelted fixing agent doesn't fix the interval of the layers sufficiently in the comparative example. Therefore, the preform loses shape during transportation and cannot be used for the RTM forming.

### EXAMPLES

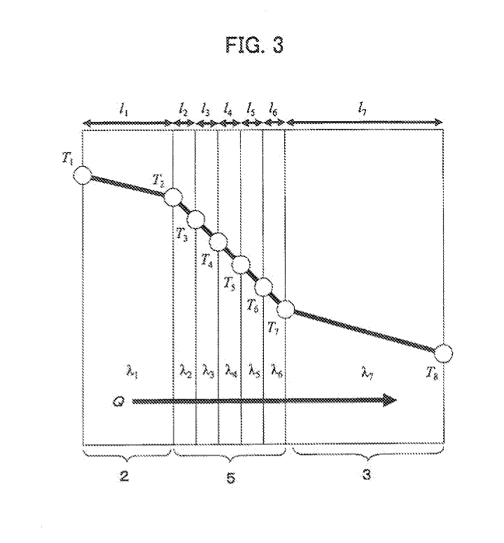

FIG. 3 is a schematic characteristic diagram showing a temperature distribution in an example. FIG. 3 schematically describes the temperature at each section in a condition where layered body 5 (consisting of five layers) of the reinforcing-fiber base material is interposed between lower mold 2 as first mold and upper mold 3 as second mold and heat transfer Q is generated from lower mold 2 to upper mold 3. T(T₁-T₈) indicates each temperature (° C.) of contact face at each section, l(l₁-l₇) indicates each thickness (m) of each layer, and λ(λ₁-λ₇) indicates each thermal conductivity (W/m·K) of each material.

In FIG. 3, if it is assumed that lower mold 2, upper mold 3 and layers of layered body 5 are regarded as plane parallel plates coherent to each other, the contact thermal resistance on the contact faces between the layers is ignored and heat transfer Q is caused based on a steady heat conduction (T₁ is constant and T₈ is constant), transferred heat quantity q (W/m²) can be expressed by the following formula (1).

$$q = \frac{( {T}_{1} - {T}_{8} )}{{\sum }_{n = 1}^{8} \frac{{l}_{n}}{{λ}_{n}}} \qquad ( 1 )$$

Here, T2 to T7 can be expressed by the following formula (2) (where 2≦i≦7).

$${T}_{i} = {T}_{1} - ( {\sum }_{n = 2}^{i} \frac{{l}_{n}}{{λ}_{n}} ) q \qquad ( 2 )$$

Tables 2 to 5 show results of T₂ to T₇ calculated by assuming that T₁ is 100° C. and T₈ is 100° C., with respect to pitch-based carbon fiber (made by Cytec Industries, Inc., Theonel K-1000, λ₂−λ₆=1000 W/m·K), PAN-based carbon fiber (made by Toray Industries, Inc., Torayca T300, λ₂−λ₆=6.5 W/m·K), and glass fiber (made by Nitto Boseki Co., Ltd, E-glass series, λ₂−λ₆=1.03 W/m·K).

Here assumed l₁=0.02 m, l₂-l₆=0.0015 m, and l₇=0.1 m.

Table 2 shows calculation results of a case where lower mold 2 is made of aluminum (λ₁=228 W/m·K) and upper mold 3 is made of aluminum (λ₇=228 W/m·K).

TABLE 2

| | T₁ (° C.) | T₂ (° C.) | T₃ (° C.) | T₄ (° C.) | T₅ (° C.) | T₆ (° C.) | T₇ (° C.) | T₈ (° C.) |
|---|---|---|---|---|---|---|---|---|
| Pitch-based | 100.0 | 99.9 | 87.5 | 87.3 | 87.0 | 86.8 | 86.6 | 25.0 |
| carbon fiber | | | | | | | | |
| (λ₂₋₆ = 1000 W/m · K) | | | | | | | | |
| PAN-based | 100.0 | 99.9 | 85.8 | 75.5 | 65.2 | 54.9 | 44.6 | 25.0 |
| carbon fiber | | | | | | | | |
| (λ₂₋₆ = 6.5 W/m · K) | | | | | | | | |
| Glass fiber | 100.0 | 99.9 | 85.2 | 71.2 | 57.2 | 43.2 | 29.2 | 25.0 |
| (λ₂₋₆ = 1.03 W/m · K) | | | | | | | | |

Table 3 shows calculation results of a case where lower mold 2 is made of aluminum (λ₁=228 W/m·K) and upper mold 3 is made of resin (λ₇=1.5 W/m·K).

TABLE 3

| | T₁ (° C.) | T₂ (° C.) | T₃ (° C.) | T₄ (° C.) | T₅ (° C.) | T₆ (° C.) | T₇ (° C.) | T₈ (° C.) |
|---|---|---|---|---|---|---|---|---|
| Pitch-based | 100.0 | 99.9 | 99.9 | 99.9 | 99.9 | 99.9 | 99.9 | 25.0 |
| carbon fiber | | | | | | | | |
| (λ₂₋₆ = 1000 W/m · K) | | | | | | | | |
| PAN-based | 100.0 | 99.9 | 99.6 | 99.4 | 99.1 | 98.9 | 98.6 | 25.0 |
| carbon fiber | | | | | | | | |
| (λ₂₋₆ = 6.5 W/m · K) | | | | | | | | |
| Glass fiber | 100.0 | 99.9 | 98.4 | 97.0 | 95.5 | 94.0 | 92.5 | 25.0 |
| (λ₂₋₆ = 1.03 W/m · K) | | | | | | | | |

Table 4 shows calculation results of a case where lower mold 2 is made of carbon steel (λ₁=45 W/m·K) and upper mold 3 is made of carbon steel (λ₇=45 W/m·K).

TABLE 4

| | T₁ (° C.) | T₂ (° C.) | T₃ (° C.) | T₄ (° C.) | T₅ (° C.) | T₆ (° C.) | T₇ (° C.) | T₈ (° C.) |
|---|---|---|---|---|---|---|---|---|
| Pitch-based | 100.0 | 99.5 | 87.5 | 87.5 | 87.4 | 87.4 | 87.3 | 25.0 |
| carbon fiber | | | | | | | | |
| (λ₂₋₆ = 1000 W/m · K) | | | | | | | | |
| PAN-based | 100.0 | 99.5 | 86.7 | 82.2 | 77.7 | 73.2 | 68.6 | 25.0 |
| carbon fiber | | | | | | | | |
| (λ₂₋₆ = 6.5 W/m · K) | | | | | | | | |
| Glass fiber | 100.0 | 99.6 | 85.7 | 74.7 | 63.7 | 52.7 | 41.8 | 25.0 |
| (λ₂₋₆ = 1.03 W/m · K) | | | | | | | | |

Table 5 shows calculation, results of a ease where lower mold 2 is made of carbon steel (λ₁=45 W/m·K) and upper mold 3 is made of resin (λ₇=1.5 W/m·K).

TABLE 5

| | T₁ (° C.) | T₂ (° C.) | T₃ (° C.) | T₄ (° C.) | T₅ (° C.) | T₆ (° C.) | T₇ (° C.) | T₈ (° C.) |
|---|---|---|---|---|---|---|---|---|
| Pitch-based | 100.0 | 99.5 | 99.5 | 99.5 | 99.5 | 99.5 | 99.5 | 25.0 |
| carbon fiber | | | | | | | | |
| (λ₂₋₆ = 1000 W/m · K) | | | | | | | | |
| PAN-based | 100.0 | 99.5 | 99.3 | 99.0 | 98.8 | 98.5 | 98.2 | 25.0 |
| carbon fiber | | | | | | | | |
| (λ₂₋₆ = 6.5 W/m · K) | | | | | | | | |
| Glass fiber | 100.0 | 99.6 | 98.1 | 96.6 | 95.1 | 93.7 | 92.2 | 25.0 |
| (λ₂₋₆ = 1.03 W/m · K) | | | | | | | | |

As apparent from Tables 2 and 4, in the case where upper mold 3 located far from the source of heat is made of thermally conductive aluminum, or carbon steel, the difference of temperatures is smaller in upper mold 3 and, therefore, the temperature on the surface of upper mold 3 decreases. Particularly in the case where the reinforcing-fiber base material is made of less thermally conductive PAN-based carbon fiber or glass fiber, heat conduction from lower mold 2 becomes smaller and therefore, the temperature on the surface of upper mold 3 decreases greatly.

However, in the case where upper mold 3 is replaced by the one made of less thermally conductive resin, heat transfer is limited inside upper mold 3 and, therefore, the difference of temperature is greater so that the temperature decrease in each layer of the reinforcing-fiber base material can be reduced even if the reinforcing-fiber base material is made of less thermally conductive PAN-based carbon fiber or glass fiber.

According to the above-described calculation results, if upper mold 3 is made of thermally conductive material, it is likely in a real preform manufacturing apparatus that the heat transfer is progressively performed inside upper mold 3 and, therefore, it takes a long time to increase the temperature of each layer of the reinforcing-fiber base material near upper mold 3. On the other hand, if upper mold 3 is made of less thermally conductive material, the heat transfer is limited inside upper mold 3 and, therefore, the temperature near upper mold 3 is prevented from decreasing so that the temperature of each layer of the reinforcing-fiber base material is increased rapidly even if the reinforcing-fiber base material is made of less thermally conductive PAN-based carbon fiber.

### INDUSTRIAL APPLICATIONS

The manufacturing apparatus and manufacturing method of a preform is applicable to any use where preforms are required to be formed with a high accuracy as saving energy for an RTM forming method.

1.-16. (canceled)

17. A manufacturing apparatus of a preform to be used for an RTM forming, wherein a layered body consisting of a plurality of layered reinforcing-fiber base materials to which a fixing agent consisting primarily of a thermoplastic resin is attached is formed by heating into a predetermined shape, comprising a forming mold consisting of a first mold and a second mold facing each other, wherein only the first mold is provided with a heating mechanism and a contact face of the second mold contacting the reinforcing-fiber base material is made of a material which is less thermally conductive than the first mold.

18. The apparatus according to claim 17, wherein the contact face is made of a material having a thermal conductivity which is equal to or more than 0.01 W/m·K and is equal to or less than 10 W/m·K.

19. The apparatus according to claim 17, wherein the contact face is made of a nonmetallic material having a thickness of at least 5 mm.

20. The apparatus according to claim 17, wherein the first mold is made of a metallic material.

21. The apparatus according to claim 17, wherein the second mold is a split mold.

22. The apparatus according to claim 17, wherein the fixing agent has a glass transition temperature of 50-80° C.

23. The apparatus according to claim 17, wherein the reinforcing-fiber base material is a carbon fiber base material.

24. A method of manufacturing preforms to be used in RTM forming, comprising:
pressing a layered body consisting of a plurality of layered reinforcing-fiber base materials to which a fixing agent consisting primarily of a thermoplastic resin is attached with a forming mold consisting of a first mold and a second mold facing each other to form a predetermined shape;
heating the predetermined shape to melt the fixing agent interposed among the reinforcing-fiber base materials only from a first mold side and a contact face of the second mold contacting the reinforcing-fiber base material is made of a material which is less thermally conductive than the first mold so as to suppress the heat from being conducted to the second mold side, and
cooling to solidify the fixing agent to make the reinforcing-fiber base materials adhere to each other to maintain a formed shape.

25. The method according to claim 24, wherein the contact face is made of a material having a thermal conductivity which is equal to or more than 0.01 W/m·K and is equal to or less than 10 W/m·K.

26. The method according to claim 24, wherein the contact face is made of a nonmetallic material having a thickness of at least 5 mm.

27. The method according to claim 24, wherein the first mold is made of a metallic material.

28. The method according to claim 24, wherein the second mold is a split mold.

29. The method according to claim 24, wherein the fixing agent has a glass transition temperature of 50-80° C.

30. The method according to claim 24, wherein the cooling is performed while the layered body is pressed.

31. The method according to claim 24, wherein the reinforcing-fiber base material is a carbon fiber base material.

32. A preform for RTM forming and manufactured by a method comprising:
pressing a layered body consisting of a plurality of layered reinforcing-fiber base materials to which a fixing agent consisting primarily of a thermoplastic resin is attached with a forming mold consisting of a first mold and a second mold facing each other to form a predetermined shape;
heating the predetermined shape to melt the fixing agent interposed among the reinforcing-fiber base materials only from a first mold side and a contact face of the second mold contacting the reinforcing-fiber base material is made of a material which is less thermally conductive than the first mold so as to suppress the heat from being conducted to the second mold side, and
cooling to solidify the fixing agent to make the reinforcing-fiber base materials adhere to each other to maintain a formed shape.
